(19) United States
(12) Patent Application Publication
(10) Pub. No.: US 2011/0062745 A1
(43) Pub. Date: Mar. 17, 2011

(54) FOLDING TOP FOR A CONVERTIBLE VEHICLE

(75) Inventor: Jason Bowles, Owosso, MI (US)

(73) Assignee: Webasto-Edscha Cabrio GmbH, Stockdorf (DE)

(21) Appl. No.: 12/872,476

(22) Filed: Aug. 31, 2010

Related U.S. Application Data
(60) Provisional application No. 61/275,525, filed on Aug. 31, 2009.

(51) Int. Cl. B60J 7/12

(52) U.S. Cl. 296/107.09

(57) ABSTRACT

A folding top for a convertible vehicle that includes at least one folding top portion, wherein the folding top is displaceable between an open position and a closed position, wherein the folding top portion has an internal surface oriented towards a vehicle passenger compartment and an external surface oriented towards a vehicle external area when the folding top is in the closed position, and wherein a solar absorption area of a conversion device for converting solar energy into electrical energy is mounted on the external surface of the folding top portion.

The invention relates to a folding top for a convertible vehicle.

### BACKGROUND

Conversion devices for converting solar energy into electrical energy are known in practice. Such conversion devices are typically installed at locations regularly exposed to insolation and serve for storing energy or supplying energy to electrical consumers generally electrically connected directly to the conversion unit. One use commonly encountered is the arrangement of such conversion devices on the roofs of houses. To convert the insolation into electrical energy, use is often made of semiconductor-based photovoltaic cells, which convert the insolation absorbed directly into electrical voltage. Known conversion devices here comprise a plurality of photovoltaic cells, which together form a solar absorption area for absorbing insolation. A conversion device furthermore comprises at least one electrical circuit for the electrical termination of the photovoltaic cells and for delivering an output voltage.

DE 102 47 856 A1 describes a vehicle body part for a motor vehicle, which comprises a substrate, a thin-film solar cell arranged on the substrate and a transparent surface film.

DE 103 48 118 A1 describes a vehicle body part for a motor vehicle having an organic solar cell.

### SUMMARY OF THE INVENTION

An object of the invention is to specify a folding top for a convertible vehicle, which will allow the direct exploitation of solar energy.

According to an aspect of the invention this object is achieved by a folding top for a convertible vehicle having at least one folding top portion, wherein the folding top is displaceable between an opened position and a closed position, wherein the folding top portion has an internal surface oriented towards a vehicle passenger compartment and an external surface oriented towards a vehicle external area when the folding top is in the closed position, and wherein a solar absorption area of a conversion device for converting solar energy into electrical energy is mounted on the external surface of the folding top portion.

According to a further aspect of the invention, this object is achieved by a convertible vehicle, comprising a folding top having a surface, and a conversion device for converting solar energy into electrical energy, wherein the conversion device comprises at least one solar absorption area for absorbing solar energy, and wherein the at least one solar absorption area forms at least a part of the surface of the folding top.

According to a still further aspect of the invention, this object is achieved by a folding top for a convertible vehicle, comprising at least one constituent surface designed to absorb solar energy, a conversion device for converting solar energy absorbed into electrical energy, and transmission means for transmitting the converted electrical energy to an electrical consumer.

Mounting the solar absorption area of the conversion device on the external surface of the folding top advantageously creates a folding top for a convertible vehicle, which reliably allows electrical energy to be generated directly from solar energy. The external surface facing towards a vehicle external area when the folding top is in the closed position is regularly exposed to the insolation when the folding top is closed, so that a considerable amount of energy can advantageously be delivered by means of the conversion device. The provision of the conversion device on a part belonging to the folding top advantageously allows an energy supply to electrical consumers located on the folding top which is independent of an electrical system of the convertible vehicle fixed to the vehicle body.

The folding top portion is suitably embodied as a rigid-shell part. The rigid-shell part forms a torsionally stiff and comparatively vibration-free substrate of the solar absorption area and thus affords protection against mechanical damage to the solar absorption area. The rigid-shell part is nevertheless a part of the folding top and together with other parts of the folding top can be displaced between a closed position at least partially spanning the vehicle passenger compartment and an opened position at least partially exposing the vehicle passenger compartment. In a likewise preferred development the folding top portion is made from a flexible material, in particular from a conventional folding top fabric known in the art. In particular the folding top fabric may preferably have a multilayer construction, suitably with at least one insulating layer, thereby already affording sufficient rigidity for mounting of the solar absorption area.

The conversion device preferably comprises photovoltaic cells, which are arranged on the external surface of the folding top portion. Insolation incident upon the solar absorption area can thus advantageously be converted directly into electrical energy. Photovoltaic cells furthermore have a high reliability and an adequate service life, so that replacement or repair of the solar absorption area is generally not necessary during the life of the folding top. Nevertheless it is possible to provide a facility for replacement of the solar absorption area independently of a replacement of the folding top portion. The conversion device suitably comprises a plurality of photovoltaic cells, which are connected to one another by means of a suitable electrical circuit in order to deliver a desired output voltage. Here the electrical circuit is likewise suitably fitted to the folding top portion. It has to be understood that parts of the electrical circuit or the conversion device, for example a control unit or a storage unit for storing the electrical energy generated, can be provided outside the folding top portion, in particular on a part of the convertible vehicle outside the folding top and fixed to the vehicle body.

The electrical energy can preferably be stored in an energy storage unit arranged on the folding top portion. Arranging the energy storage unit on the folding top portion obviates the need for a costly transmission of the electrical energy to a component outside the folding top portion, with all the inherent electrical losses. This ensures a storage facility which is available at any time regardless of whether the folding top is in an opened or closed position. Alternatively or in addition to this an electrical consumer intended to consume the electrical energy is arranged on the folding top portion, so that storage of the converted electrical energy can be dispensed with.

A folding top locking system can preferably be operated by means of the electrical energy delivered by the conversion device. In the closed position of the folding top the locking system suitably locks a front bow of the folding top to a cowl of the windshield of the convertible vehicle, in order to achieve a more secure positioning of the folding top in the closed position. Where the electrical energy delivered by the conversion device or an energy storage unit assigned to the conversion device is not sufficient for a full operation of the locking device, an electrical supply to the locking device is suitably provided by an electrical system of the convertible vehicle. It has to be understood that a facility for manual operation of the locking system can be provided as an alternative or addition to this.

A displacement of the folding top between the closed position and the opened position can preferably be driven at least partially by means of electrical energy delivered by the conversion device. For this purpose an electric motor driving the displacement is suitably electrically connected to the conversion device. It has to be understood that, besides a fully driven displacing movement, support for a manual operation or a separate drive device are also feasible.

Connections are preferably provided for the transmission of electrical energy via contacts arranged in the area of the cowl of the convertible vehicle. When the folding top is closed this facilitates a transmission of the electrical energy to electrical consumers fixed to the vehicle body. In addition this represents a simple way of transmitting electrical energy from the conversion device to a vehicle electrical system.

It is especially preferred if the folding top portion is embodied as a front bow of the folding top. This makes it easy to integrate the folding top portion into conventional folding top arrangements for convertible vehicles, whilst at the same time ensuring sufficient rigidity for secure mounting of the solar absorption portion. It readily facilitates transmission of the electrical energy delivered via contacts provided in the cowl and the supply of energy to electrical consumers, such as a locking system, for example, fitted to the front bow. Embodiment of the folding top portion as a front bow moreover affords the facility for retrofitting to an existing folding top with conventional front bow.

With the folding top in the opened position the external surface of the folding top portion is preferably oriented towards a vehicle external area. The external surface of the folding top portion is here suitably free of covering parts when the folding top is in the opened position, the folding top portion advantageously covering other folding top parts when the folding top is in the opened position and assuming the function of a folding top box cover, for example. Thus solar energy can advantageously be converted into electrical energy by means of the conversion device even when the folding top is opened, so that an electrical energy supply to connected consumers is ensured irrespective of the position of the folding top. Should provision be made for a transmission of electrical energy from the conversion system to a system fixed to the vehicle body, contacts for a transmission of electrical energy are suitably provided in the stowage area, particularly inside a folding top box. Alternatively or in addition, electrical energy is transmitted via transmission media, for example power cables, arranged in the area of linkage parts of a folding top mechanism.

In a preferred development electrical consumers such as lighting, fans, electrically operated sensors or the like, arranged in the area of the internal surface of the folding top portion, can be operated by means of electrical energy delivered by the conversion device. For example, an electrical consumer is advantageously mounted in the immediate vicinity of the actual folding top portion, thereby obviating the need to transmit electrical energy between parts that move relative to one another and/or over longer distances.

In a first preferred development the folding top is embodied as a fabric folding top. The arrangement of the solar absorption area on the folding top portion, particularly a front bow, in this case allows a direct generation of energy by the folding top with the appearance and function of the folding top otherwise remaining unchanged. In a second, likewise preferred development the folding top is embodied as a hard-shell folding top and comprises at least two folding top parts embodied as rigid-shell parts, at last one of which forms or comprises the folding top portion. It is especially preferred if at least the majority of folding top parts are equipped with a conversion device for converting solar energy into electrical energy.

Electrical energy is advantageously converted and stored by means of the conversion device independently of any driven operation of the convertible vehicle. It is therefore possible to charge energy storage units or to supply electrical systems of the convertible vehicle with energy even when the vehicle is switched off and not in use.

It is particularly advantageous if electrical energy generated by means of the conversion device can be fed into a power circuit connected to an automobile battery of the convertible vehicle. In this case the electrical energy delivered by the conversion device can be used on the one hand to charge the automobile battery; on the other hand consumers electrically connected to the automobile battery can be supplied by means of the electrical energy delivered by the conversion device.

The folding top portion can preferably be stowed in a rear area of the convertible vehicle. With the folding top in a closed position the folding top portion is most suitably arranged so that it forms a folding top box cover. In this arrangement the folding top portion covers other parts of the folding top, so that firstly the external surface is still exposed to the insolation and secondly other parts of the folding top are protectively stowed.

Further advantages and features of the invention are set forth in the following description of a preferred exemplary embodiment.

The invention will be explained in more detail below on the basis of a first exemplary embodiment and with reference to the figures attached.

### BRIEF DESCRIPTION OF THE DRAWINGS

FIG. 1 shows a schematic side view of parts of a convertible folding top embodied as a fabric folding top, when the folding top is closed.

FIG. 2 shows the folding top in FIG. 1 in the opened position.

### DETAILED DESCRIPTION

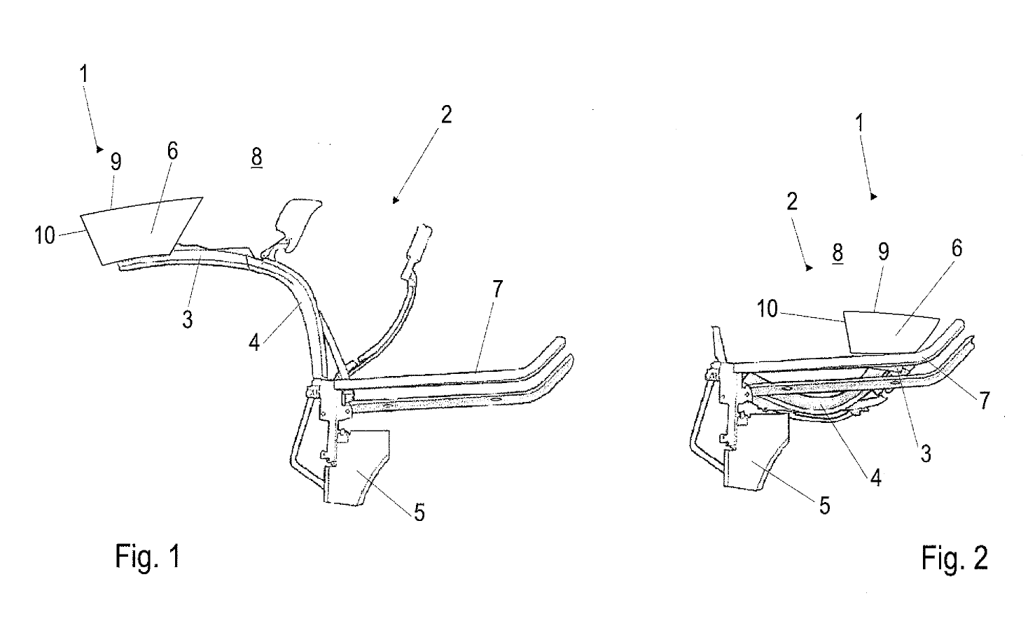

The folding top 1 represented in FIG. 1 and FIG. 2 for a convertible vehicle is embodied as a fabric folding top. As can be seen, the folding top 1 comprises a guide linkage 2, which when the folding top 1 is in the closed position stretches the folding top fabric (not shown) over the vehicle passenger compartment. The guide linkage 2 comprises a roof frame on each side of the vehicle having a first, rear roof frame element 3 and a second, front roof frame element 4. The first roof frame element 3 is part of a main guide link mechanism embodied as a main four-bar linkage and is rotatably fastened to a bearing element 5 fixed to the vehicle body. A folding top portion 6, which is embodied as front bow, is mounted on the guide linkage 2 and when the folding top 1 is closed spans the vehicle passenger compartment in a transverse direction of the vehicle. The guide linkage 2 has a tensioning bow 7 at the rear, which with the folding top closed stretches a rear end of the folding top fabric in a rearward direction and therefore tensions the folding top fabric. As can clearly be seen from FIG. 2, with the folding top 1 in the opened position the folding top portion 6 covers a part of the guide linkage 2. An external surface 9 of the folding top portion 6 facing an external area 8 of the convertible vehicle when the folding top is closed here also faces the external area 8 in the opened position of the folding top 1. Solar radiation is therefore incident on the external surface 9 of the folding top portion 6 both in the closed position and in the opened position of the folding top 1.

The external surface 9 of the folding top portion 6 comprises a solar absorption area having a plurality of photovoltaic cells, which together with an electrical circuit connecting them form a conversion device for converting solar energy into electrical energy. When the external surface 9 of the folding top portion 6 is exposed to sunlight, electrical energy is delivered by the conversion device. A front edge 10 of the folding top portion 6 forming the front bow and bearing against a cowl of the convertible vehicle when the folding top is closed has electrical contacts, which when the folding top is closed are in connection with electrical contacts arranged on the cowl, so that electrical energy delivered by the conversion device can be transmitted via the contacts to the electrical system of the convertible vehicle. Also mounted on the folding top portion 6 is an energy storage unit in the form of a lithium ion accumulator, in which electrical energy delivered by the conversion device can be stored.

It has to be understood that electrical consumers, such as a locking system, lighting, ventilation means, sensor systems and/or drive systems, for example, arranged on the folding top 1 and in particular on the folding top portion 6, can be directly supplied with electrical energy by means of the conversion device regardless of the position of the folding top and independently of an electrical system of the convertible vehicle.

What is claimed is:

1. A folding top for a convertible vehicle having at least one folding top portion,
wherein the folding top is displaceable between an opened position and a closed position,
wherein the folding top portion has an internal surface oriented towards a vehicle passenger compartment and an external surface oriented towards a vehicle external area when the folding top is in the closed position, and
wherein a solar absorption area of a conversion device for converting solar energy into electrical energy is mounted on the external surface of the folding top portion.

2. The folding top as claimed in claim 1, wherein the folding top portion is embodied as a rigid-shell part.

3. The folding top as claimed in claim 1, wherein the conversion device comprises photovoltaic cells, which are arranged on the external surface of the folding top portion.

4. The folding top as claimed in claim 1, wherein electrical energy can be stored in an energy storage unit arranged on the folding top portion.

5. The folding top as claimed in claim 1, wherein a locking system of the folding top can be operated by means of electrical energy delivered by the conversion device.

6. The folding top as claimed in claim I, wherein a displacement of the folding top between the closed position and the opened position can be at least partially driven by means of electrical energy delivered by the conversion device.

7. The folding top as claimed in claim 1, wherein connections are provided for the transmission of electrical energy via contacts arranged in the area of a cowl of the convertible vehicle.

8. The folding top as claimed in claim 1, wherein the folding top portion is embodied as a front bow.

9. The folding top as claimed in claim 1, wherein the external surface of the is folding top portion is oriented towards a vehicle external area when the folding top is in the opened position.

10. The folding top as claimed in claim 1, wherein the external surface of the folding top portion is free of covering parts when the folding top is in the opened position.

11. The folding top as claimed in claim 1, wherein lighting arranged in the area of the internal surface can be operated by means of electrical energy delivered by the conversion device.

12. The folding top as claimed in claim 1, wherein the folding top is embodied as a fabric folding top.

13. The folding top as claimed in claim 1, wherein the folding top is embodied as a hard-shell folding top.

14. The folding top as claimed in claim 1, wherein electrical energy is converted and stored by means of the conversion device independently of any vehicle operation of the convertible vehicle.

15. The folding top as claimed in claim 1, wherein electrical energy generated by means of the conversion device can be fed into a power circuit connected to an automobile battery of the convertible vehicle.

16. The folding top as claimed in claim 1, wherein the folding top portion, at least in sections of the external surface, is embodied as a solar panel.

17. The folding top as claimed in claim 1, wherein the folding top portion can be stowed in a rear area of the convertible vehicle.

18. The folding top as claimed in claim 1, wherein the folding top portion forms a folding top box cover when the folding top is in the closed position.

19. A convertible vehicle, comprising
a folding top having a surface, and a conversion device for converting solar energy into electrical energy,
wherein the conversion device comprises at least one solar absorption area for absorbing solar energy, and
wherein the at least one solar absorption area forms at least a part of the surface of the folding top.

20. A folding top for a convertible vehicle, comprising
at least one constituent surface designed to absorb solar energy, a conversion device for converting solar energy absorbed into electrical energy, and
transmission means for transmitting the converted electrical energy to an electrical consumer.
